(19) United States
(12) Patent Application Publication
(10) Pub. No.: US 2014/0278700 A1
(43) Pub. Date: Sep. 18, 2014

(54) SYSTEMS AND METHODS OF PRIORITIZING INITIATIVES

(71) Applicant: Cbeyond, Atlanta, GA (US)

(72) Inventors: DAVID R. GRANTIER, CUMMING, GA (US); CHRISTOPHER J. WATKINS, ALPHARETTA, GA (US); ANDREW BRYANT, CLARKSTON, GA (US); REED C. SELLERS, POWDER SPRINGS, GA (US); RAVI VENKATESAN, ATLANTA, GA (US); DENISE ROGERS, MARIETTA, GA (US); RHONDA CAPONE, ATLANTA, GA (US); CARRIE ANN WHEELER, DECATUR, GA (US)

(73) Assignee: Cbeyond, Atlanta, GA (US)

(21) Appl. No.: 14/205,972

(22) Filed: Mar. 12, 2014

Related U.S. Application Data
(60) Provisional application No. 61/790,217, filed on Mar. 15, 2013.

(51) Int. Cl. G06Q 10/06

(52) U.S. Cl. CPC G06Q 10/06313
USPC 705/7.23

(57) ABSTRACT

A system that receives plurality of data that includes dimensions (e.g., revenue, profit margin, level of effort, urgency or alignment to the organization's technology strategy) and criteria (e.g., business unit, product, or service) that are relevant to drive an organization's priorities. The system generates a visual display on which a representation (e.g., a sphere, circle, square, or other shape) for each of the projects is depicted. In various embodiments, the user may select one dimension to be used as an x-axis scale of the visual display and a second dimension to be used as a y-axis scale of the visual display. The system plots a representation for each project against various dimensions that are meaningful to the business organization.

### CROSS REFERENCE TO RELATED APPLICATION

This application claims the benefit of U.S. Provisional Patent Application No. 61/790,217, filed Mar. 15, 2013, entitled, “Systems and Methods of Prioritizing Initiatives,” which is hereby incorporated herein by reference in its entirety.

### BACKGROUND

Project planning and prioritization is complex, may involve large amounts of data and may be based on many variables. The project management data may relate to a company's long term business goals, long term technology roadmap and urgency of the project, among other variables. As such, visualization of current and potential projects is helpful for making project decisions.

### SUMMARY OF THE INVENTION

A system for prioritizing initiatives and providing a visual representation of the initiatives across multiple dimensions comprises at least one processor, a display operatively coupled to the at least one processor and memory operatively coupled to the at least one processor. The at least one processor is configured to receive a plurality of data associated with a plurality of initiatives, where the data further comprises a plurality of dimensions associated with each of the plurality of initiatives. In various embodiments, the dimensions may include a business case priority, an alignment of the initiative with a technology roadmap, a level of effort necessary to complete the initiative, the urgency associated with the initiative, etc.

The at least one processor is also configured to calculate a first score for a first dimension and a second score for a second dimension for each of the plurality of initiatives based on at least some of the plurality of data associated with each one of the initiatives. The at least one processor is further configured to generate a chart that includes a representation of each of the plurality of initiatives plotted against an x-axis scale that is based on the first dimension and y-axis scale that is based on the second dimension. In various embodiments, the size of the representation of each of one of the initiatives is based on a third dimension associate with respectively with each one of the initiatives. Finally, the at least one processor adjusts the color of the representation for each one of initiatives based on a fourth dimension associated respectively with each one of the initiatives.

In various embodiments, the first score for the first dimension may be a weighted score that is based on multiple prioritization factors and/or revenue projections. In some embodiments, the third dimension may be based on a scale of one to ten.

### BRIEF DESCRIPTION OF THE FIGURES

A full and enabling disclosure of the present invention, including the best mode thereof directed to one of ordinary skill in the art, is set forth in the specification, which makes reference to the appended drawings, in which:

FIG. 1 is a block diagram of a project prioritization system according to a particular embodiment;

FIG. 2 is a block diagram of a computer that is suitable for use within the project prioritization system of FIG. 1;

FIG. 3 is an input user interface for entering project and scoring information;

FIG. 4 is an input user interface for entering project scoring information;

FIG. 5 is a user interface that shows various scored business initiatives in accordance with the project prioritization system of FIG. 1;

FIG. 6 is a user interface that shows a filtered subset of various scored business initiatives in accordance with the project prioritization system of FIG. 1;

FIG. 7 is a user interface that shows a filtered subset of various scored business initiatives in accordance with the project prioritization system of FIG. 1;

FIG. 8 is a user interface that shows a filtered subset of various scored business initiatives in accordance with the project prioritization system of FIG. 1;

FIG. 9 is a user interface that shows a filtered subset of various scored business initiatives in accordance with the project prioritization system of FIG. 1; and

FIG. 10 is a flowchart of a project prioritization module according to a particular embodiment.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made to the present invention without departing from the scope or spirit thereof. For instance, features illustrated or described as part of one embodiment may be used in another embodiment to yield a still further embodiment. Thus, the present invention covers such modifications and variations as come within the scope of the appended claims and their equivalents. Like numbers refer to like elements throughout.

### System Overview

A computer system, according to various embodiments, is adapted to prioritize investment in any number of project requests. For purposes of this disclosure, the terms “project” and “initiative” are generically used to mean an investment of time, money and/or resources in a particular activity for a business, an enterprise, an organization or a larger activity that comprises multiple sub-activities to complete.

In various embodiments, the system allows the user to create dimensions (e.g., revenue, profit margin, level of effort, urgency or alignment to the organization's technology strategy) and criteria (e.g., business unit, product, or service) that are relevant to drive an organization's priorities. Additionally, the project prioritization system generates a visual chart on which a representation (e.g., a sphere, circle, square, or other shape) for each of the projects can be depicted. In various embodiments, the user may select one dimension to be used as the x-axis scale of the visual chart and a second dimension to be used as the y-axis scale of the visual chart. Thus, the system plots a sphere for each project on the chart against various dimensions that are meaningful to the business organization. For purposes of this disclosure, the project prioritization system is shown as a web hosted system. However, in some embodiments, the system may also be locally hosted on a server where users interact with the system over a wide area network or a local area network. In still other embodiments, the system may be executed locally on a personal computer.

Exemplary Technical Platforms

As will be appreciated by one skilled in the relevant field, the present invention may be, for example, embodied as a computer system, a method, or a computer program product. Accordingly, various embodiments may take the form of an entirely hardware embodiment or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

FIG. 1 is a block diagram of a project planning system 100 according to a particular embodiment. As may be understood from this figure, project planning system 100 includes one or more remote computing devices such as a desktop computer 102 or a mobile computing device 104 (e.g., a laptop or a handheld computing device) that are in communication with a web server 108, which, for example, may be used to execute a project prioritization module, and a database 112 (which, for example, may be used to store the web content and received data as discussed below) via one or more computer networks 110. The one or more computer networks 110 may include any of a variety of types of wired or wireless computer networks such as the Internet. The communication link between web server 108 and database 112 may be, for example, implemented via a Local Area Network (LAN) or via the Internet.

FIG. 2 illustrates a diagrammatic representation of a computer 108 that can be used within project planning system 100. For purposes of this disclosure, reference to a server or processor, shall be interpreted to include either a single server, a single processor, or multiple servers, or multiple processors.

In particular embodiments, computer 108 may be connected (e.g., networked) to other computers in a LAN, an intranet, an extranet, and/or the Internet. Computer 108 may operate in the capacity of a server or a client computer in a client-server network environment, or as a peer computer in a peer-to-peer (or distributed) network environment. Computer 108 may be a personal computer (PC) 102, mobile computing device 104 (e.g., a tablet PC, a handheld device, or a Personal Digital Assistant (PDA)), a server, or any computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

The exemplary computer 108 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

Processing device 202 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 202 may also be one or more special-purpose processing devices such as an application specific integrated circuit (ASIC), a field programmable gate array (FPGA), a digital signal processor (DSP), network processor, or the like. Processing device 202 may be configured to execute processing logic 226 for performing various operations and steps discussed herein.

Computer 108 may further include a network interface device 208. Computer 108 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

Data storage device 218 may include a non-transitory computer-accessible storage medium 230 (also known as a non-transitory computer-readable storage medium or a non-transitory computer-readable medium) on which is stored one or more sets of instructions (e.g., the method steps embodied by the project prioritization module 114) embodying any one or more of the methodologies or functions described herein. The project prioritization module 114 may also reside, completely or at least partially, within main memory 204 and/or within processing device 202 during execution thereof by computer 108, main memory 204 and processing device 202 also constituting computer-accessible storage media. The project prioritization module 114 may further be transmitted or received over a network 220 via network interface device 208.

While computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” shall also be understood to include any medium that is capable of storing, encoding or carrying a set of instructions for execution by the computer and that cause the computer to perform any one or more of the methodologies of the present invention. The term “computer-accessible storage medium” shall accordingly be understood to include, but not be limited to, solid-state memories, optical and magnetic media, etc.

Exemplary User Interface Panes

An exemplary user interface for a particular project prioritization system according to a particular embodiment is shown in FIGS. 3-4. Exemplary visual charts for a particular project prioritization system according to an embodiment are shown in FIG. 5-9.

Data Input Screen

Referring to FIG. 3, a user interface 116 for data input is shown having input fields arranged in columns 118, 120, 122, 124, 126, 128, 130 and 132. It should be understood from reference to this disclosure that the data input screen may take any form that allows the user to enter data associated with a particular project or initiative. In the particular example shown in the figure, a group of business initiatives (column 118) are listed and scored using various dimensions and criteria. Examples of various dimensions include, but are not limited to, business case priority (column 120), revenue, profit margin, size of workforce, technology roadmap alignment (column 122), level of effort necessary to complete the initiative (column 124), the urgency of the initiative (column 126), and the status of the initiative (column 130). Other criteria may also be entered such as the type of project or initiative (e.g., group responsible for the initiative) (column 128). Lastly, the project may contain a filter designator (column 132) that allows certain projects to be filtered by the user. The filter designator allows a large number of initiatives to be filtered to a subset based on specific criteria. For example, “functional alignment” may be a filter with sub-options (e.g., Sales & Marketing, Operations and Technology). Thus, if prioritization needs to occur within sales & marketing or the user wishes to only review those initiatives associated with sales & marketing, then the user can select the filter option of “sales & marketing”. In the example illustrated in FIG. 3, initiatives are prioritized across “business case priority” (Column 120), “technology roadmap alignment” (Column 122), “relative level of effort” (Column 124), “urgency” (Column 126) and “project status” (Column 130).

Column 118 of the data fields provides a name listing of each initiative to be prioritized and evaluated. Columns 120 and 122 are the main dimensions used to plot a representation (e.g., a sphere) for each of the competing initiatives. In various embodiments, column 120 represents the scale for the x-axis 134 (FIG. 5) of the visual plot and column 122 represents the scale for the y-axis 136 (FIG. 5) of the plot.

In the particular example shown, column 120 is assigned the first dimension of “business case priority.” Business case priority relates to the importance of the initiative to the business (e.g., does the project make sense from a business perspective). FIG. 4 illustrates a user interface 138 that allows the user to input prioritization factors 140, impact selections 142 and related values 144 that are used to calculate a net score 146 and a weighted score 148 for the business case priority. Examples of prioritization factors include, but are not limited to, alignment with corporate imperatives 150, business productivity impact 152, customer satisfaction 154, regulatory or statutory requirements 156 and revenue impact 158. In various embodiments, the business case priority is scored on a scale from zero to fifty but, may be scored over other ranges.

Referring once again to FIG. 3, column 122 is assigned the second dimension of “technology alignment.” Technology alignment looks at the technology characteristics of a particular project or initiative and compares that to the business' technology roadmap or key technology drivers. Thus, the more aligned an initiative is with the business' technology roadmap, the higher the score assigned to the initiative. In various embodiments, technology alignment is scored on a scale from zero to fifty but, may be scored over other ranges.

Column 124 of the data input screen is assigned the third dimension of “level of effort.”Level of effort may represent the level of manpower necessary to complete the initiative, the amount of money necessary to complete the initiative or a combination of manpower and expense. The level of effort can be ranked on a scale of one to ten where one represents a low level of effort and ten represents a large effort. The data input for the “level of effort” effects the size of the sphere for the initiative in the chart. Said another way, the size of the sphere for the initiative indicates it relative complexity with respect to other spheres on the chart.

Column 126 of the data input screen is assigned the fourth dimension of “urgency.” For example, an initiative to replace a phone system that no longer functions may be considered much more urgent than an initiative to upgrade an accounting system that is still operable since the former may immediately affect the organizations ability to do business while the latter may improve efficiency over the long run. Urgency may be represented by the color assigned to a sphere. For example, the color “red” may be used to indicate an initiative that is very urgent and must be completed as soon as possible. The color “orange” may indicate an initiative that is urgent but, will not affect the organizations ability to service customers or generate revenue. The color “yellow” may be used to indicate an initiative that is still less urgent than the colors “red” and “orange.” The color “green” may indicate something that is not urgent such as a long-term project, and the color “blue” may represent an initiative that has not been prioritized based on urgency. An example of an initiative that may not be prioritized by urgency may be, for example, integrating systems and processes from a recent acquisition. The urgency level may depend on a decision to keep these systems and processes isolated for a period of time or integrate to drive efficiencies. Thus, while this decision is in the process of being made, the urgency level may show up as “blue” or not yet decided.

Column 128 of the data input screen is assigned a criteria of “program,” which may be used to associate the particular initiative with a group within the organization (e.g., sales or operations), a product, a service or any other indicator that will allow the user to filter or group initiatives for evaluation.

Column 130 of the data input screen is assigned the fifth dimension of “status,” which may be used to illustrate the status of the initiative (e.g., not started, in progress or complete). In the example presented, the status may either be shown as “not started” or “complete.” Status is illustrated on the chart based on the opacity of the sphere for an initiative. That is, a solid sphere represents an initiative that has not been started and a transparent sphere represents an initiative that has been completed.

Exemplary Data Chart

FIG. 5 illustrates a data chart 171 that contains spheres 172-180 for each of the initiatives listed in column 118 of the data input screen 116 shown in FIG. 3. The chart has the x-axis scale 134 based on the business case priority dimension of column 120 and a y-axis scale 136 based on the alignment to the technology road map of column 122. The chart is broken into four segments: “dormancy” 182, “necessity” 184, “purity” 186, and “harmony” 188. Initiatives that fall into the “dormancy” quadrant (e.g., spheres 170 and 172) are initiatives that have a low business case priority ranking and that also do not align well with the technology roadmap. An example may be an initiative to use social media to interact with customers. In the short run, this may not be relevant to the business since it does not save money or generate revenue. Moreover, the use of social media may not be aligned with the technology roadmap. However, over time communicating with customers using social media may provide the impression that the business is technology savvy, which may appeal to customers. Thus, initiatives in the dormancy quadrant 182 should be re-evaluated in the future since the business case priority and alignment with the technology roadmap can change over time.

Initiatives (e.g., 260 and 162) that fall in the “purity” quadrant 186 are initiatives that are aligned with the technology roadmap but have a low business case priority score. Purity initiatives are typically not urgent in nature. Thus, purity initiatives are typically prioritized over the mid-long term since they typically advance the overall direction of the company with a low impact on revenues. An example of a purity initiative would be the use of chat to interact with customers. Such an initiative may have a low business case priority since the use of chat will not save money nor increase revenues. However, the organization may want to be perceived as having advanced technology and the use of chat may align well with the technology roadmap.

Initiatives (e.g., 264, 168, 174, 176 and 178) that fall into the “harmony” quadrant 188 are initiatives that are highly aligned with the technology roadmap and that present a strong business case (e.g., saves money, increases revenue, increases productivity). Harmony initiatives are typically initiatives that the organization should invest in and that may require follow-up. These types of initiatives tend to be more urgent since they typically have a direct impact on the organization.

Finally, initiatives (e.g., 168, 176 and 189) that fall into the “necessity” quadrant 184 are initiatives that have a high business case priority but are not well aligned with the technology roadmap. Necessity initiatives tend to be more urgent since they directly impact the operation of the organization, even though they may not be aligned to the technology roadmap. An example of a necessity initiative may be the replacement of analog telephone lines with digital telephone lines. Upgrading to digital lines may save the company money in the short term by providing stable telephone lines with upgraded features but, upgrading the lines may not be aligned well with the technology roadmap since the technology roadmap may include moving to voice over IP. More importantly, if the use of analog lines reduce the organizations ability to service customers, the upgrade may be considered very urgent.

Still referring to FIG. 5, the chart of competing initiatives allows a user to view the relevancy of initiatives based on two main dimensions that are important to the organization. Additionally, the system also allows each initiative to be ranked by other relevant dimensions within the same chart. For example, as described above, the third dimension of “level of effort” may be represented by the size of the sphere relative to other spheres. For example, Call Center Integration initiative 170 will require much more effort than the “Project Accounting Upgrade” initiative 172. Moreover, the level of urgency associated with an initiative may be represented by the color assigned to the sphere. Thus, for example, a user may easily select initiatives that require little effort to complete and that are very urgent by selecting all small spheres that are colored red (e.g., the “sales enablement” initiative 180). In this way, the user can easily evaluate which initiatives are urgent and easy to complete by merely looking at a visual representation of the initiatives on a chart.

Large organizations may have many concurrent initiatives that are competing for common limited resources (e.g., manpower and funding). Thus, the project prioritization system has the ability to filter initiatives by any one or more dimensions or criteria. Thus, referring to FIG. 6, the user may filter the chart 171 results by the “urgency” dimension to see only those initiatives that are marked very urgent. In this case, the two initiatives “bandwidth boost” 178 and “sales enablement” 180 are displayed in a manner that easily allows the user to evaluate urgent initiatives.

Referring to FIG. 7, the user may also filter the chart 171 results by the “program” criteria 128 (FIG. 3) to see all initiatives for certain programs such as sales and products. Thus, spheres 168, 176, 178, and 180 for initiatives having sales or products “program” criteria 128 will only be displayed on the chart 171.

Referring to FIG. 8, the user may also filter the chart 171 results to show all initiatives that require a particular level of effort (e.g., a level of effort of greater than six). Thus, spheres 164, 170 and 174 for all initiatives that require a level of effort greater than six are displayed on the chart 171. Finally, FIG. 9 illustrates initiatives filtered by the dimension of “status.” As a result, the spheres 174 and 178 shown in the chart 171 are for all initiatives that are marked completed.

It should be understood with reference to this disclosure that filtering does not have to be done on a single dimension or criteria. In fact, the user may filter the initiatives by any combination of dimensions and criteria that allows the user to evaluate relevant initiatives.

Exemplary Operation

The system of FIG. 1 may be configured to perform the method steps of FIG. 10. Moreover, the method described in FIG. 10 is an example of an embodiment of a present method for presenting and prioritizing multiple initiatives according to various factors. It should be understood by reference to this disclosure that the method describes an exemplary embodiment of the method steps carried out by the present system, and that other exemplary embodiments may be created by adding other steps or by removing one or more of the method steps described in FIG. 10.

FIG. 10 depicts an exemplary method for displaying and prioritizing multiple initiatives. Web server 112 may alone, or in combination with other computers, processors or servers, perform the method steps of the computer implemented method. The method beings at step 300 where the system receives a plurality of data, each of the plurality of data being associated with a respective plurality of initiatives. In various embodiments, one or more of the plurality of data may be associated with any one initiative. Once the data is received, in various embodiments, the data may be stored in memory for later use.

At step 302, the system determines a first dimension for each of the plurality of initiatives by calculating a first score for each of the plurality of initiatives. The first score may be based on any one or more of the plurality of data associated with each one of the plurality of initiatives. In various embodiments, the first score may be a weighted score based on a plurality of prioritization factors and revenue projections that are included in the plurality of data. In various embodiments, the first dimension score relates to a business case priority.

At step 304, the system determines a second dimension for each of the plurality of initiatives by calculating a second sore for each of the plurality of initiatives. The second score may be based on any one or more of the plurality of data associated with each one of the plurality of initiatives. In various embodiments, the second score may be a weighted score based on multiple factors included in the plurality of data. In various embodiments, the second dimension score relates to the alignment of the initiative with a technology roadmap.

At step 306, the system is configured to generate a chart that includes a representation of each of the plurality of initiatives plotted against the x-axis scale 134 that is based on the first dimension and a y-axis scale 136 that is based on the second dimension. In various embodiments the representation can be a two-dimensional representation in any shape (e.g., a circle, a square, a rectangle, a triangle, etc.) or three-dimensional representation in any shape (e.g., a sphere, a cube, a prism, a rhombohedrum, a cone, etc.). In a particular embodiment, the representation of each initiative is in the shape of a sphere.

At step 308, the system is configured to adjust the size of the representation associated with each of the plurality of initiatives based on a third dimension that is determined from at least a portion of the respective plurality of data associated with each initiative. In various embodiments, the third dimension may be based on a scale of one to ten. In other embodiments, the third dimension may be a weighted score that is based on the manpower and cost associated with the initiative. In various embodiments, the size of the representation for each initiative may be based on the level of effort that is necessary to complete that initiative. In other embodiments, the size of the representation may be based on the amount of money that is necessary to complete an initiative. It should be understood from reference to this disclosure that the size of a representation for an initiative may be representative of any dimension associated with data for that initiative.

At step 310, the system is further configured to adjust the color of the representation of each of the plurality of initiatives based on a fourth dimension determined from at least a second portion of the respective plurality of data associated with each initiative. For example, the color of a representation may be indicative of the sense of urgency associated with the initiative. Thus, in various embodiments, very urgent initiatives may be red, urgent initiatives may be yellow, non-urgent initiatives may be green, etc. In various embodiments, the opacity of the color associated with a representation may be associated with a fifth dimension associated with the initiative. For example, the opacity of the representative may be based on a fifth dimension that is determined from at least a third portion of the respective plurality of data associated with each initiative. For example the opacity of color may be virtually see through when an initiative has not been started and it may be solid when the initiative has been completed.

Finally, at step 312, the chart is displayed to a user on a screen. In various embodiments, the screen may be a computer monitor associated with the server, and in other embodiments, the screen may be a computer monitor associated with a desktop computer or mobile computing device.

### CONCLUSION

Many modifications and other embodiments of the invention will come to mind to one skilled in the art to which this invention pertains having the benefit of the teachings presented in the foregoing descriptions and the associated drawings. In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A system for prioritizing initiatives and providing a visual representation of the initiatives across multiple dimensions, the system comprising:
a. at least one processor;
b. a display operatively coupled to the at least one processor;
c. memory operatively coupled to the at least one processor,
wherein the at least one processor is configured to:
i. receive a plurality of data associated with a plurality of initiatives, wherein the data further comprises a plurality of dimensions associated with one or more of the plurality of initiatives;
ii. calculate a first score for a first dimension for each one of the plurality of initiatives;
iii. calculate a second score for a second dimension for each of the plurality of initiatives;
iv. generate a chart that includes a representation of each one of the plurality of initiatives plotted against an x-axis scale that is based on the first dimension and y-axis scale that is based on the second dimension;
v. adjust the size of the representation associated with each one of the plurality of initiatives based on a third dimension that is associated with each respective one of the plurality of initiatives;
vi. adjust the color of the representation associated with each one of the plurality of initiatives based on a fourth dimension that is associated with each respective one of the plurality of initiatives.

2. The system of claim 1, wherein the received data is stored in the memory.

3. The system of claim 1, wherein the first score for the first dimension is a weighted score based on a plurality of prioritization factors and revenue projections that are part of the plurality of data.

4. The system of claim 1, wherein the third dimension is based on a scale of one to ten.

5. The system of claim 1, wherein:
a. the first dimension score relates to a business case priority;
b. the second dimension score relates to an alignment of the initiative with a technology roadmap;
c. the third dimension relates to the level of effort necessary to complete the initiative; and
d. the fourth dimension relates to the urgency of the initiative.

6. The system of claim 1, wherein the at least one processor is configured to adjust the opacity of the representation of each one of the plurality of initiatives based on a status of each respective initiative.

7. The system of claim 1, wherein the representation is selected from a group consisting of:
a. a two dimensional shape; and
b. a three-dimensional shape.

8. The system of claim 7, wherein the shape is a sphere.

9. The system of claim 1, wherein the color of a representation is selected from a group consisting of:
a. red;
b. green;
c. yellow; and
d. blue

10. The system of claim 9, wherein the color red represents an initiative that is urgent.

11. A computer-implemented method of prioritizing proposed initiatives based on a plurality of dimensions comprising:
a. receive a plurality of data, each plurality of data being associated with a respective initiative;
b. determining a first dimension for each initiative by calculating a first score for each initiative, wherein the first score is based on at least a first portion of the respective plurality of data associated with the initiative;
c. determining a second dimension for each initiative by calculating a second score for each initiative, wherein the second score is based on at least a second portion of the respective plurality of data associated with the initiative;
d. generating a chart that includes a representation of each initiative plotted against an x-axis scale that is based on the first dimension and y-axis scale that is based on the second dimension;
e. adjusting the size of the representation of each initiative based on a third dimension determined from at least a third portion of the respective plurality of data associated with each initiative; and
f. adjusting the color of the representation of each initiative based on a fourth dimension determined from at least a fourth portion of the respective plurality of data associated with each initiative.

12. The computer-implemented method of claim 11, further comprising adjusting the opacity of the representation of each initiative based on a fifth dimension determined from at least a portion of the respective plurality of data associated with each initiative.

13. The computer-implemented method of claim 11, further comprising displaying the chart of a monitor.

14. The computer-implemented method of claim 12, further comprising filtering the representations included on the chart based on at least one of the first dimension, the second dimension, the third dimension, the fourth dimension and the fifth dimension.

15. The computer-implemented method of claim 14, wherein the representations on the chart are filtered by the third dimension and the fourth dimension.

16. The computer-implemented method of claim 11, wherein the first dimension relates to a business case priority and the second dimension relates to alignment with a technology roadmap.

17. A non-transitory computer-readable medium storing a program that causes a computer to execute the display of initiatives on a chart that allows a user to prioritize the initiatives, the display of initiatives comprising:
a. receive a plurality of data, each plurality of data being associated with a respective initiative;
b. determining a first dimension for each initiative by calculating a first score for each initiative, wherein the first score is based on at least a first portion of the respective plurality of data associated with the initiative;
c. determining a second dimension for each initiative by calculating a second score for each initiative, wherein the second score is based on at least a second portion of the respective plurality of data associated with the initiative;
d. generating a chart that includes a representation of each of initiative plotted against an x-axis scale that is based on the first dimension and y-axis scale that is based on the second dimension;
e. adjusting the size of the representation of each initiative based on a third dimension determined from at least a third portion of the respective plurality of data associated with each initiative; and
f. adjusting the color of the representation of each initiative based on a fourth dimension determined from at least a fourth portion of the respective plurality of data associated with each initiative.

18. The non-transitory computer-readable medium of claim 17, wherein the first dimension relates to a business case priority and the second dimension relates to alignment with a technology roadmap.

19. The non-transitory computer-readable medium of claim 17, wherein the display of initiatives further comprises adjusting the opacity of the representation of each initiative based on a fifth dimension determined from at least a fifth portion of the respective plurality of data associated with each initiative.

20. The non-transitory computer-readable medium of claim 17, wherein the third dimension relates to the level of effort needed to complete the initiative.
